(19) United States
(12) Patent Application Publication
(10) Pub. No.: US 2026/0189438 A1
(43) Pub. Date: Jul. 2, 2026

(54) APPARATUS AND METHOD FOR PROCESSING SIGNAL RECEIVED BY RECEPTION DEVICE IN WIRELESS COMMUNICATION SYSTEM

(71) Applicants: SAMSUNG ELECTRONICS CO., LTD., Suwon-si (KR); POSTECH RESEARCH AND BUSINESS DEVELOPMENT FOUNDATION, Pohang-si (KR)

(72) Inventors: Yonwoo YOON, Suwon-si (KR); Taejun JANG, Pohang-si (KR); Joonho CHO, Pohang-si (KR); Hayoung YANG, Suwon-si (KR)

(73) Assignees: SAMSUNG ELECTRONICS CO., LTD., Suwon-si (KR); POSTECH RESEARCH AND BUSINESS DEVELOPMENT FOUNDATION, Pohang-si (KR)

(21) Appl. No.: 19/546,009

(22) Filed: Feb. 20, 2026

Related U.S. Application Data
(63) Continuation of application No. PCT/KR2024/005346, filed on Apr. 19, 2024.

(30) Foreign Application Priority Data
Aug. 20, 2023 (KR) 10-2023-0108699
Sep. 6, 2023 (KR) 10-2023-0118470

(51) Int. Cl. H04L 25/02

(52) U.S. Cl. CPC H04L 25/024

(57) ABSTRACT

A method performed by a reception device, includes: estimating a delay value for a strongest path for a received signal; estimating a Doppler shift value for the strongest path based on the received signal and the delay value; estimating a gain value for the strongest path based on the received signal, the delay value, and the Doppler shift value; estimating a channel matrix of the strongest path based on the delay value, the Doppler shift value, and the gain value; in a case that an iteration stop condition for stopping an iteration of the above estimating operations is satisfied, acquiring a frequency domain estimation signal and a frequency domain estimation channel matrix by converting the received signal and the channel matrix into a frequency domain; and estimating a transmission signal corresponding to the received signal based on the frequency domain estimation signal and the frequency domain estimation channel matrix.

### CROSS-REFERENCE TO RELATED APPLICATIONS

This application is a by-pass continuation application of International Application No. PCT/KR2024/005346, filed on Apr. 19, 2024, which is based on and claims priority to Korean Patent Application No. 10-2023-0108699, filed on Aug. 20, 2023, and Korean Patent Application No. 10-2023-0118470, filed on Sep. 6, 2023, in the Korean Intellectual Property Office, the disclosures of which are incorporated by reference herein their entireties.

### BACKGROUND

### 1. Field

The disclosure relates to a wireless communication system, and more particularly, to a channel estimator-equalizer structure in a channel environment where a high Doppler shift occurs.

### 2. Description of Related Art

The 5^{th} generation mobile communication standard has been developed to provide very high data transmission rates and very low latency in various environments, and the 6ₜₕ generation mobile communication standard is also currently being discussed. These environments include not only vehicle-to-everything (V2X) communication and high-speed trains (HST), where high Doppler shifts occur, but also non-terrestrial networks (NTN) scenarios such as communication with unmanned aerial vehicles (UAVs) and satellites. In these environments, user equipment may move at a very high speed, so a very large Doppler shift may occur. Since Doppler shift may significantly degrade the performance of a receiver, accurate and prompt estimation and correction are important. However, existing Doppler shift estimation and correction deal with environments with relatively low Doppler shift occurrence, such as vehicles moving on highways, so high Doppler shifts such as high-speed trains and NTN environments cannot be handled. Therefore, there is a need to develop new channel estimators and equalizers with low complexity and high reception performance suitable for 5ₜₕ and 6ₜₕ generation mobile communication standards.

### SUMMARY

The present disclosure proposes a procedure for processing a signal received by a reception device in a wireless communication system. More specifically, the present disclosure proposes a channel estimator-equalizer having low complexity and high reception performance in a channel environment in which a high Doppler shift occurs, such as high-speed trains and NTN.

According to an aspect of the present disclosure, a method performed by a reception device in a wireless communication system, includes: a first operation of estimating a delay value for a strongest path for a received signal; a second operation of estimating a Doppler shift value for the strongest path based on the received signal and the delay value; a third operation of estimating a gain value for the strongest path based on the received signal, the delay value, and the Doppler shift value; a fourth operation of estimating a channel matrix of the strongest path based on the delay value, the Doppler shift value, and the gain value; in a case that an iteration stop condition for stopping an iteration of the first operation to the fourth operation is satisfied, a fifth operation of acquiring a frequency domain estimation signal and a frequency domain estimation channel matrix by converting the received signal and the channel matrix into a frequency domain; and a sixth operation of estimating a transmission signal corresponding to the received signal based on the frequency domain estimation signal and the frequency domain estimation channel matrix.

According to an aspect of the present disclosure, a reception device includes: a matched filter configured to perform sampling of a received signal to generate a received signal vector; a channel estimator; and a channel equalizer, wherein the channel estimator is configured to perform: a first operation of estimating a delay value for a strongest path for the received signal; a second operation of estimating a Doppler shift value for the strongest path based on the received signal and the delay value; a third operation of estimating a gain value for the strongest path based on the received signal, the delay value, and the Doppler shift value; and a fourth operation of estimating a channel matrix of the strongest path based on the delay value, the Doppler shift value, and the gain value, and wherein the channel equalizer is configured to perform: in a case that an iteration stop condition for stopping an iteration of the first operation to the fourth operation is satisfied, a fifth operation of acquiring a frequency domain estimation signal and a frequency domain estimation channel matrix by converting the received signal and the channel matrix into a frequency domain; and a sixth operation of estimating a transmission signal corresponding to the received signal based on the frequency domain estimation signal and the frequency domain estimation channel matrix.

According to the present disclosure, operations for processing a signal received by a reception device in a wireless communication system may be efficiently improved.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a structure of a receiver including an estimator-equalizer according to an embodiment of the disclosure;

FIG. 2 illustrates a structure of a single-path delay estimator according to an embodiment of the disclosure;

FIG. 3 illustrates a structure of a single-path Doppler shift estimator according to an embodiment of the disclosure;

FIG. 4 illustrates a structure of a single-path gain estimator according to an embodiment of the disclosure;

FIG. 5 illustrates a structure of a single-path channel matrix estimator according to an embodiment of the disclosure;

FIG. 6 illustrates a structure of a noise standard deviation estimator according to an embodiment of the disclosure;

FIG. 7 illustrates a structure of a channel equalizer according to an embodiment of the disclosure;

FIG. 8 is a flowchart of the operation of a channel estimator-equalizer according to an embodiment of the disclosure;

FIG. 9 illustrates an operation method of an embodiment in which a channel estimator-equalizer performs timing adjustment according to an embodiment of the disclosure;

FIG. 10 illustrates an operation method of performing re-estimation of a gain value and estimation of a noise standard deviation by a channel estimator-equalizer according to an embodiment of the disclosure;

FIG. 11 is a graph illustrating a SINR performance when channel estimation and channel equalization are performed by using a channel estimator-equalizer according to an embodiment of the disclosure;

FIG. 12 illustrates an embodiment in which a channel estimator-equalizer adjusts timing by using a delay peak of the strongest path according to an embodiment of the disclosure; and

FIG. 13 illustrates an embodiment in which a channel estimator-equalizer integrates the energy of the first arriving path according to an embodiment of the disclosure.

### DETAILED DESCRIPTION

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

Hereinafter, various embodiments of the disclosure will be described based on an approach of hardware. However, various embodiments of the disclosure include a technology that uses both hardware and software, and thus the various embodiments of the disclosure may not exclude the perspective of software.

Furthermore, various embodiments of the disclosure will be described using terms used in some communication standards (e.g., the 3rd generation partnership project (3GPP)), but they are for illustrative purposes only. Various embodiments of the disclosure may also be easily applied to other communication systems through modifications.

The disclosure is to provide a channel estimator and an equalizer with low complexity and high reception performance suitable for 5G and 6G mobile communication standards. In particular, the channel estimator and equalizer of the disclosure may provide low complexity and high reception performance in a high-speed train (HST) or HST-like channel environment. For example, the channel estimator and the equalizer of the disclosure may be used in a high-Doppler scenario such as a high speed (scenario) that deals with communication between a high-speed train on a railway and a radio remote head.

In the high-speed train scenario, there are transceivers such as baseband units (BBUs) and remote radio heads (RRHs) fixed around the railway, on-board relays installed on some carriages, and UEs such as mobile phones inside the carriages. The on-board relay is characterized by its role in concentrating signals from within the carriage for transmission and reception. The disclosure addresses the uplink of a high Doppler channel, thus covering the link between BBUs and RRHs with very high Doppler shifts and the on-board relay.

In such a scenario, the train may move at a maximum of 500 km/h, thus causing a very large Doppler shift. In a situation (mono-static arrangement) where the uplink receiver and the downlink transmitter are not facing opposite directions but facing the same direction, the on-board relay transmits a uplink signal by correcting the frequency based on the downlink received signal, so the amount of Doppler shift of the line-of-sight (LOS) path received by the uplink receiver is twice the actual propagation Doppler frequency. Due to such a feature, a very high Doppler shift may occur, which may cause a significant intercarrier interference. In addition, in cyclic prefix-orthogonal frequency division multiplexing (CP-OFDM), reception of Doppler in each OFDM symbol is not continuous due to the CP, and the CP length may be different in some OFDM symbols.

For example, in a case where the RRH receives a signal in the high speed train (HST) uplink scenario, when analyzing the ratio of time when the CIR is 15 dB or less (subcarrier offset is 10% or more) when the Doppler shift is not corrected, the CIR is 15 dB or less more than 85% of the time when crossing from one RRH to the next. In such a channel, the use of a conventional simple one-tap equalizer without frequency offset correction may not allow the SINR to exceed 15 dB, making it impossible to guarantee proper reception performance.

In the HST channel, since linear cells are also assumed, the number of paths is very small, and the location or movement of an on-board relay is limited, it is expected that a base station may easily learn and handle information on the uplink channel environment. Due to these characteristics, machine learning as well as learning-based channel estimation using an adaptive algorithm may be considered. In particular, since the LoS path has a large correlation between the angle of arrival (AoA) and Doppler, it is possible to consider associating each location on the railway with a specific AoA value, and storing or learning the delay, relative Doppler, and relative gain of the paths at each location, and using this for channel estimation.

The disclosure provides a channel estimator-equalizer having low complexity and high reception performance in a multi-path channel environment in which a very high Doppler shift may occur when using CP-OFDM or a similar DFT-s-OFDM. Specifically, an estimator for estimating a multi-path channel by estimating delay, Doppler shift, and gain for each path using pilot symbols (or demodulate reference signal (DMRS) symbols) in one slot, and an operation method of an equalizer combined with such an estimator to equalize a channel with low complexity are jointly presented.

Hereinafter, a channel estimator-equalizer according to an embodiment of the disclosure will be described with reference to the drawings.

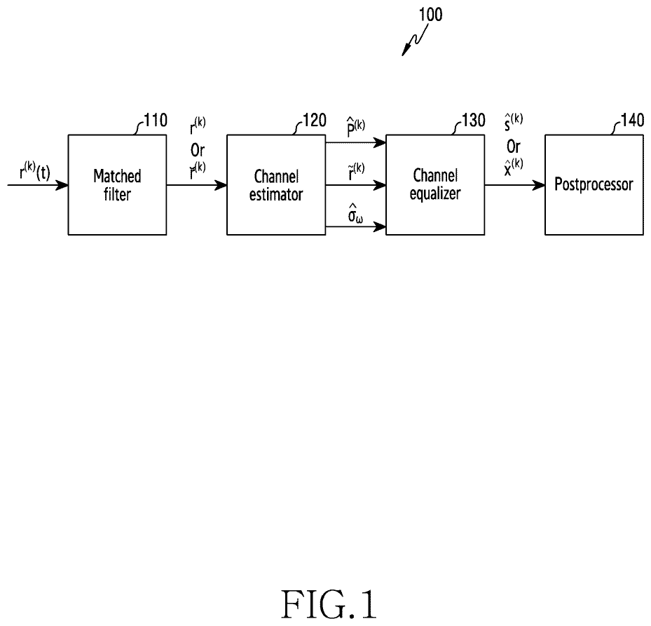

FIG. 1 illustrates a structure of a receiver including a channel estimator-equalizer according to an embodiment of the disclosure. The structure illustrated in FIG. 1 is an example of a structure of a receiver, and is not intended to limit the structure of a receiver. For example, the receiver may be a cyclic prefix-orthogonal frequency division multiplexing (CP-OFDM) receiver or a discrete Fourier transform-spread-orthogonal frequency division multiplexing (DFT-s-OFDM) receiver.

Referring to FIG. 1, a receiver 100 may include a matched filter 110, a channel estimator 120, a channel equalizer 130, and a postprocessor 140. Such a structure may be implemented by hardware, software, or a combination of hardware and software.

The matched filter 110 may perform sampling on the received signal to generate a received signal vector and then transfer the same to the channel estimator 120 and the channel equalizer 130. For example, the matched filter 110 may sample or oversample r^{(k)}(t) for a kₜₕ OFDM symbol in a slot received by the receiver 100. The matched filter 110 may generate a received signal vector r^{(k)} of the kₜₕ OFDM symbol and transfer the same to the channel estimator 120 and the channel equalizer 130.

In the time domain received signal model of CP-OFDM or a waveform similar thereto, the received signal vector r^{(k)} of the kₜₕ OFDM symbol having a size of N×1 may be expressed as a sum of a vector acquired by multiplying a transmission signal vector s^{(k)} of the kₜₕ OFDM symbol having a size of N×1 by a corresponding time domain channel matrix P^{(k)} having a size of N×N and a noise signal vector w^{(k)} having a size of N× 1. The received signal vector r^{(k)} sampled by the matched filter 110 may be represented by Equation 1.

$${r}^{( k )} = {P}^{( k )} {s}^{( k )} + {w}^{( k )} \qquad [ Equation 1 ]$$

In Equation 1, k is a value indicating which OFDM symbol a corresponding OFDM symbol is in a slot, and when one slot is composed of 14 OFDM symbols, k may have an integer value of 1 or more and 14 or less. N is the IFFT size of CP-OFDM.

In the V time oversampled received signal model in the time domain, the oversampled received signal vector [symbol] ^{(k)} of the kₜₕ OFDM symbol having a size of VN×1 may be expressed as the sum of a vector acquired by multiplying the transmission signal vector s^{(k)} of the kₜₕ OFDM symbol by the corresponding time oversampled channel matrix [symbol] ^{(k)} having a size of VN×N and the oversampled noise signal vector [symbol] ^{(k)} having a size of VN×1. The received signal vector [symbol] ^{(k)} oversampled by the matched filter 110 may be represented by Equation 2.

$${( k )}^{} = {( k )}^{} {s}^{( k )} + {( k )}^{} \qquad [ Equation 2 ]$$

When the channel matrix P^{(k)} of the time domain received signal model of Equation 1 is expressed as a sum of L paths, the following Equation 3 for the multi-path channel may be acquired.

$${r}^{( k )} = {\sum }_{l = 1}^{L} {α}_{l} {\tilde{P}}^{( k )} ( {τ}_{l} , {v}_{l} ) {s}^{( k )} + {w}^{( k )} \qquad [ Equation 3 ]$$

When τ₁, ν₁, αₗ represents the gain, delay, and Doppler shift of the lₜₕ path, respectively, αₗ\tilde{P}^{(k)}(τ₁, ν₁) may represent the lₜₕ path channel. In Equation 3, \tilde{P}^{(k)} (τ, ν) having a size of N×N represents a channel matrix of the kₜₕ OFDM symbol having a delay τ and Doppler shift ν. Equation 3 may be equally applied to the oversampled received signal of Equation 2.

In the case of gain 1, the kₜₕ OFDM symbol \tilde{P}^{(k)}(τ, ν) having a delay τ and Doppler shift ν may be expressed by Equation 4.

$${\tilde{P}}^{( k )} ( τ , v ) = {\tilde{P}}_{0}^{( k )} ( τ , v ) + {\tilde{P}}_{- 1}^{( k )} ( τ , v ) ⊙ [ {0}_{( N - {N}_{C P} ) \times N} {1}_{{N}_{C P} \times N} ] \qquad [ Equation 4 ]$$

In Equation 4, the function \tilde{P}^{(k)}(τ, ν) is a matrix having a size of N×N, and k is a value indicating which OFDM symbol a corresponding OFDM symbol is in a slot, and when one slot is composed of 14 OFDM symbols, k may have an integer value of 1 or more and 14 or less. This equation is an example when a cyclic prefix (CP) is considered, and may vary according to the structure of a symbol and a waveform.

The part without the cyclic prefix in Equation 4 may be represented as in Equation 5 below. In the case of gain 1, the part without the cyclic prefix in the kₜₕ OFDM symbol \tilde{P}^{(k)}(τ, ν) having a delay τ and Doppler shift ν is expressed by Equation 5.

$${[ {\tilde{P}}_{0}^{( k )} ( τ , v ) ]}_{m , n} = {A}_{p} ( ( m - n ) {T}_{c} - τ , - v ) \cdot {e}^{j π v [ τ + ( 2 {\tilde{N}}^{( k )} + m + n ) {T}_{c} ]} \qquad [ Equation 5 ]$$

In Equation 5, Tc is a sample period and Ap(τ, ν) is an ambiguity function of a shaping pulse p (t) when matched filtering is performed.

When the length of the cyclic prefix is the same as N_{CP} in all OFDM symbols, the starting sample location of the kₜₕ OFDM symbol may be represented by Equation 6.

$${\tilde{N}}^{( k )} = ( k - 1 ) ( {N}_{C P} + N ) \qquad [ Equation 6 ]$$

p(t) is a square root Nyquist pulse. For example, when the shaping pulse p(t) is given as a sinc function, the ambiguity function may be expressed as in Equation 7. However, this is merely an example, and p(t) is not limited to a sinc function.

$${A}_{p} ( τ , ν ) = \{ \begin{matrix}\frac{sin ( \frac{π τ}{{T}_{c}} ( 1 - \vert ν \vert {T}_{c} ) )}{πτ} , for \vert ν \vert < \frac{1}{{T}_{c}} \\ 0 , for \vert ν \vert \geq \frac{1}{{T}_{c}}\end{matrix} \qquad [ Equation 7 ]$$

Unlike Equation 5, only the cyclic prefix part in Equation 4 may be expressed as in Equation 8. In the case of gain 1, the channel matrix of the kₜₕ OFDM symbol having a delay τ and Doppler shift ν is expressed by Equation 8. Tc is a sample period and Ap(τ, ν) is an ambiguity function of a shaping pulse p(t) when matched filtering is performed.

$${[ {\tilde{P}}_{- 1}^{( k )} ( τ , ν ) ]}_{m , n} = {A}_{p} ( ( m - n + N ) {T}_{c} - τ , - ν ) \cdot {e}^{j πν [ τ + ( 2 {\tilde{N}}^{( k )} + m + n - N ) {T}_{c} ]}$$

The channel estimator 120 estimates a channel by using the received signal vector r^{(k)} (or oversampled received signal vector [symbol] ^{(k)}) acquired by sampling r^{(k)}(t), and then transmits the estimation channel matrix \hat{P}^{(k)} for which the Doppler shift of the strongest path is corrected, the received vector \tilde{r}^{(k)} for which the Doppler shift of the strongest path is corrected, and the noise standard deviation estimation value \hat{σ}_{w} to the channel equalizer 130. The estimation channel matrix \hat{P}^{(k)} for which the Doppler shift of the strongest path is corrected may refer to a channel matrix of kₜₕ OFDM symbol estimated up to now from the iₜₕ iteration.

The channel equalizer 130 may acquire an estimation value ŝ^{(k)} (or an estimation value \hat{x}^{(k)} of the frequency domain OFDM symbol transmission vector x^{(k)}) of the time domain OFDM symbol transmission vector s^{(k)} by using \hat{P}^{(m)}, \tilde{r}^{(k)}, \hat{σ}_{w}.

The channel estimator-equalizer of the disclosure may acquire an estimation value for a multi-path channel by iteratively using a single-path channel estimator for multiple paths, stop the iteration when a sufficient number of paths have been estimated, and acquire an estimation value for a transmission signal based on the acquired estimation value for the multi-path channel.

The magnitude of the received signal used for the single-path channel estimation decreases by the influence of the estimated single path as the single-path channel estimation is iterated. For example, if the received signal vector of the kₜₕ OFDM symbol (transmitted from the matched filter 110) used when the first round of single-path channel estimation is performed by the channel estimator 120 of FIG. 1 is r^{(k)}, then

$${r}_{( 1 )}^{( k )}$$

may be used, in which the influence of the first single path is removed from r^{(k)} when the second single-path channel estimation is performed. When the third round of single-path channel estimation is performed,

$${r}_{( 2 )}^{( k )} ,$$

in which the influence of a single path for which the second estimation is performed is removed from

$${r}_{( 1 )}^{( k )} ,$$

may be used.

When single-path channel estimation has been iterated i times, a residual received signal

$${r}_{( i )}^{( k )}$$

in which the influence of the previous single path has been removed may be represented by Equation 9.

$${r}_{( i )}^{( k )} = \{ \begin{matrix}{r}^{( k )} , i = 0 \\ {[ {R}^{( k )} ( {\hat{ν}}_{1} ) ]}^{H} {r}_{( 0 )}^{( k )} - {\hat{α}}_{1} {\tilde{P}}^{( k )} ( {\hat{τ}}_{1} , 0 ) {s}^{( k )} , i = 1 \\ {r}_{( i - 1 )}^{( k )} - {\hat{α}}_{i} {\tilde{P}}^{( k )} ( {\hat{τ}}_{i} , {\hat{ν}}_{i} - {\hat{ν}}_{1} ) {s}^{( k )} , i = 2 , 3 , …\end{matrix} \qquad [ Equation 9 ]$$

In the case of the first estimation (i=0), the residual received signal may be assumed to be the same as the entire received signal. In subsequent estimation (i=1, 2, . . . ), a residual received signal, from which the influence of previously estimated single path is removed, may be used. The influence from the previously estimated single path that is removed here refers to the estimated received signal. However, the Doppler shift of the strongest path in the received signal is corrected and used. \hat{τ}ᵢ, \hat{ν}ᵢ, \hat{α}ᵢ represent estimation values of the iₜₕ received signal's delay, Doppler shift, and gain, respectively. Equation 9 may also be applied when using the oversampled received signal of Equation 2. R^{(k)}(ν) in Equation 9 is defined in Equation 16.

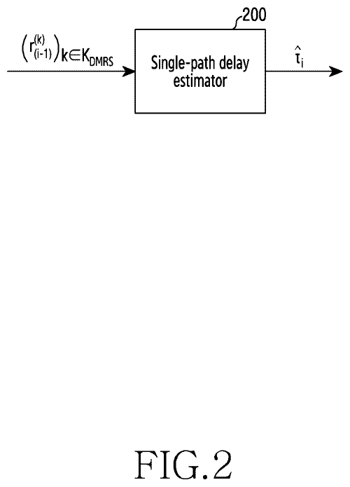

FIG. 2 illustrates a structure of a single-path delay estimator according to an embodiment of the disclosure.

Referring to FIG. 2, the single-path delay estimator 200 estimates a path delay \hat{τ}ᵢ based on a residual received signal of pilot symbols

$${r}_{( i - 1 )}^{( k )} ,$$

k∈ [symbol] _{DMRS}.

The single-path delay estimator 200 may estimate the iₜₕ path delay by using a non-coherent combining correlator. Specifically, for pilot symbols (DMRS symbols), the iₜₕ path delay may be estimated by finding a delay at which the absolute value of a correlation between a received signal and a transmitted signal is the largest. Equation 10 is an equation for estimating a path delay \hat{τ} for the kₜₕ OFDM symbol in the OFDM symbol slot by finding a path delay \hat{τ} for which the absolute value of a correlation between the received signal r^{(k)} and the transmitted signal s^{(k)} is the largest.

$$\hat{τ} = {T}_{c} \cdot {arg max}_{n ∈ \{ 0 , 1 , … , N - 1 \}} {\sum }_{k ∈ {𝒦}_{DMRS}} \vert {( {r}^{( k )} )}^{H} circshift ( {s}^{( k )} , n ) \vert \qquad [ Equation 10 ]$$

The iₜₕ delay estimation value \hat{τ}ᵢ may be estimated by substituting

$${r}_{( i - 1 )}^{( k )}$$

into the r^{(k)} position. [symbol] _{DMRS} is a set of pilot symbols, and Tc denotes a sampling period. N denotes the size of an inverse fast Fourier transform (IFFT), circshift(s^{(k)}, n) denotes a function of circularly shifting a column vector s^{(k)} by n in the downward direction, and argmax(f(x)) denotes a function of acquiring x that maximizes a function f(x).

In order to implement the calculation of Equation 10 with low complexity, Equation 11, which applies a fast Fourier transform (FFT) and an inverse fast Fourier transform (IFFT), may be applied.

$$\hat{τ} = {T}_{c} \cdot {{arg max}_{n ∈ \{ 0 , 1 , … , N - 1 \}} [ {\sum }_{k ∈ {𝒦}_{DMRS}} \vert IFFT ( FFT ( {r}^{( k )} ) ⊙ {[ FFT ( {s}^{( k )} ) ]}^{*} ) \vert ]}_{n + 1} \qquad [ Equation 11 ]$$

The function

$${{arg max}_{n ∈ \{ 0 , 1 , … , N - 1 \}} [ \cdot ]}_{n + 1}$$

is used to find the largest component among the components of a vector having a size of N×1. Since the corresponding vector does not vary according to n (i.e., it is independent of n), only a single vector having N components needs to be calculated in order to calculate the same. In addition, for | [symbol] _{DMRS}| pilot symbols, IFFT having a size of N is performed once and the FFT is performed twice to calculate and sum the same, and a path delay estimation value may be acquired by acquiring a location of the largest component of the calculated vector.

According to an embodiment of the disclosure, the estimation value of the path delay may be used for timing adjustment of a received signal. For example, an estimation value of a path delay of the strongest path may be used. A method according to an embodiment may reduce the sampling rate (decimation) by performing timing adjustment of the received signal by using the estimation value of the path delay of the strongest path.

In order to improve the resolution of a path delay estimation value, an oversampled or upsampled received signal may be used. Although oversampling or upsampling a received signal has an advantage in that a path delay may be estimated with higher resolution and accuracy, an increase in the number of vector components increases the computational complexity.

The disclosure proposes a method for estimating a path delay with higher resolution and accuracy while reducing computational complexity by adjusting the timing of a received signal based on the path delay of the strongest path.

Equation 12 is an equation acquired by modifying Equation 10 in order to use an oversampled or upsampled received signal and a pilot transmission signal. In Equation 12, the number of vector components increased by V times compared to Equation 10, and the path delay may be estimated with higher resolution and accuracy.

$$\hat{τ} = \frac{{T}_{c}}{V} \cdot {{arg max}_{n ∈ \{ 0 , 1 , … , VN - 1 \}} [ {\sum }_{k ∈ {𝒦}_{DMRS}} \vert IFFT ( FFT ( {{r}^{⌣}}^{( k )} ) ⊙ {[ FFT ( {{s}^{⌣}}^{( k )} ) ]}^{*} ) \vert ]}_{n + 1} \qquad [ Equation 12 ]$$

After acquiring the path delay estimation value of the strongest path by using the oversampled or upsampled received signal, the sampling rate may be reduced (decimation) by adjusting the sampling timing of the received signal based on the path delay estimation value of the strongest path. This is because, even if the oversampled or upsampled received signal is not used in the channel estimation process iterated after acquiring the path delay estimation value of the strongest path, if a sampling timing of the received signal is matched to a reception timing of the strongest path, based on the estimation value of the path delay of the strongest path, the reception energy may be increased, and as a result, an estimation value may be acquired with high resolution and accuracy.

For a sampling interval Tc, in the case of the V time oversampled received signal (in this case, the time interval between adjacent samples is

$$\frac{{T}_{c}}{V} ) ,$$

\hat{τ}ₛₜᵣ for determining the sampling timing of the received signal, based on the reception timing of the strongest path, may be acquired by Equation 13.

$${\hat{τ}}_{str} = \frac{round ( \frac{V {\hat{τ}}_{1}}{{T}_{c}} ) {T}_{c}}{V} \qquad [ Equation 13 ]$$

Based on Equation 13, by configuring the sampling timing of the received signal to be \hat{τ}ₛₜᵣ+nT_{c} (n∈ [symbol] ), there is no need to use a V time oversampled received signal after estimating the path delay of the strongest path, so a signal having a sampling time interval of Tc (sampling interval) may be used. As a result, the sampling rate is reduced (decimation), and the complexity of subsequent channel estimation and equalization processes may be reduced.

In Equation 13, the first estimated path delay \hat{τ}₁ is estimated to be the path delay of the strongest path. Therefore, in order to receive while preserving the energy of the strongest path as much as possible (i.e., to increase the received energy), \hat{τ}ₛₜᵣ, which may decimate the sampling timing of the received signal as close to \hat{τ}₁+nT_{c} (n∈ [symbol] ) as possible, is calculated. In Equation 13, round(·) denotes a function of rounding to an integer.

Meanwhile, according to an embodiment of the disclosure, a path delay estimation value may be used for timing adjustment of the received signal. For example, the path delay estimation value of the first arriving path may be used. A method according to an embodiment may prevent a reception energy loss by performing timing adjustment of a received signal vector by using the path delay estimation value of the first arriving path.

By including N_{τ} samples (where N_{τ} is a very small non-negative integer) before the correlation peak in the path delay estimation, the reception energy loss may be prevented. A method of adjusting the timing of a received signal vector to match the path delay of the first arriving path may use Equation 14.

$${\hat{τ}}_{min} = {\hat{τ}}_{str} + round ( \frac{{min}_{l ∈ \{ 1 , 2 , … \}} {\hat{τ}}_{l} - {\hat{τ}}_{str}}{{T}_{c}} ) {T}_{c} - {N}_{τ} {T}_{c} \qquad [ Equation 14 ]$$

For example, when N_{τ}=1, \hat{τ}ₘᵢₙ becomes \hat{τ}ₛₜᵣ+nT_{c} (n∈ [symbol] ) less than

$${min}_{l ∈ \{ 1 , 2 , … \}} {\hat{τ}}_{l} .$$

### Meanwhile,

$${min}_{l ∈ \{ 1 , 2 , … \}} {\hat{τ}}_{l}$$

selects the smallest value among the delays of the estimated paths so far.

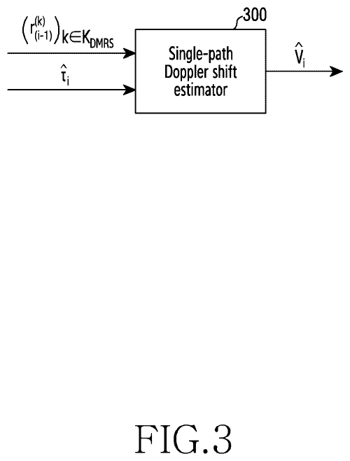

FIG. 3 illustrates a structure of a single-path Doppler shift estimator according to an embodiment of the disclosure.

Referring to FIG. 3, the single-path Doppler shift estimator 300 may acquire a path Doppler shift estimation value \hat{ν}ᵢ based on the residual received signal

$${r}_{( i - 1 )}^{( k )} ,$$

k∈ [symbol] _{DMRS} of the pilot symbols and the delay estimation value \hat{τ}ᵢ of the iₜₕ path. For example, the delay estimation value \hat{τ}ᵢ of the iₜₕ path is acquired by the single-path delay estimator 200 of FIG. 2.

The channel estimator-equalizer of the disclosure may iterate the estimation for multiple paths, and the single-path Doppler shift estimator 300 may acquire multiple path Doppler shift estimation values as a result of the iterated estimation for multiple paths. Among the multiple paths, the first path may be a path with the strongest residual received signal if there is no special circumstance.

The Doppler shift estimation value of the first path \hat{ν}₁ is always corrected in the received signal and the channel matrix in a process after the estimation of the Doppler shift of the first path. Therefore, from the second path (i≥2), \hat{ν}ᵢ−\hat{ν}₁, i≥2, which is the estimation value with corrected \hat{ν}₁, is output from the single-path Doppler shift estimator 300.

For example, the set S of candidate estimation values of the Doppler shift may be a set having elements with uniform intervals and may be expressed as in Equation 15.

$$S = \{ {v}_{min} , {v}_{min} + Δ v , … , {v}_{min} + ( M - 1 ) Δ v \} \qquad [ Equation 15 ]$$

In Equation 15, set S is defined as a set frequencies greater than or equal to νₘᵢₙ and less than or equal to νₘᵢₙ+ (M−1)Δν divided into intervals of Δν, and the number of elements in set S is M.

A matrix value function R^{(k)}(ν) for adding the frequency deviation of ν to a vector having N components may be represented by Equation 16.

$$[ Equation 16 ]$$

$${R}^{( k )} ( v ) = [ \begin{matrix}{e}^{j 2 π v ( {\tilde{N}}^{( k )} + 0 ) {T}_{c}} & 0 & … & 0 \\ 0 & {e}^{j 2 π v ( {\tilde{N}}^{( k )} + 1 ) {T}_{c}} & … & 0 \\ ⋮ & ⋮ & ⋱ & ⋮ \\ 0 & 0 & … & {e}^{j 2 π v ( {\tilde{N}}^{( k )} + ( N - 1 ) ) {T}_{c}}\end{matrix} ]$$

In Equation 16, the matrix value function R^{(k)}(ν) is a diagonal matrix having a size of N×N, the time interval between each sample is Tc, and the time of the start sample is a function of the OFDM symbol number k, and is Ñ^{(k)}T_{c}.

$$\hat{v} = {arg max}_{v ∈ S} \vert {\sum }_{k ∈ {𝒦}_{DMRS}} {[ {R}^{( k )} ( v ) \cdot circshift ( {s}^{( k )} , round ( \frac{\hat{τ}}{{T}_{c}} ) ) ]}^{H} {r}^{( k )} \vert \qquad [ Equation 17 ]$$

Equation 17 is an equation for estimating a Doppler shift of the current path based on the iₜₕ delay estimation value. The single-path Doppler shift estimator 300 of FIG. 3 may estimate a Doppler shift of the iₜₕ path using a coherent combining correlator. The circshift(‘,’) function is a function for performing a circular shift of the first parameter (vector) by the second parameter (integer).

The channel estimator-equalizer of the disclosure may circularly shift the transmission signal (acquired by the single-path delay estimator 200) by the iₜₕ path delay estimation value to align the timing with the received signal, and then may estimate the iₜₕ path Doppler variation by changing the frequency deviation of the signal and finding a Doppler deviation estimation value for which the absolute value of the correlation becomes the largest.

Equation 17 may also be applied even when the estimation value candidate set S is not defined as in the example of Equation 15 but is freely defined. \hat{ν}ᵢ, which is the iₜₕ Doppler shift estimation value, may be estimated by substituting

$${r}_{( i - 1 )}^{( k )}$$

in r^{(k)} position, and when i≥2, since a received signal having the Doppler shift of the strongest path already corrected is used, the estimation value \hat{ν} resulting from the equation is not \hat{ν}ᵢ but \hat{ν}ᵢ−\hat{ν}₁.

$${z}^{( k )} = circshift ( {s}^{( k )} , round ( \frac{\hat{τ}}{{T}_{c}} ) ) ⊙ {r}^{( k )} \qquad [ Equation 18 ]$$

Equation 18 represents a vector z^{(k)} acquired by multiplying the transmitted signal and the received signal, which are circularly shifted by the delay, by the Hadamard product.

In the path channel Doppler shift estimation method according to an embodiment of the disclosure,

$${Z}_{m}^{( k )}$$

is expressed by Equation 19 so that chirp z-transform (CZT) may be used for Doppler shift estimation for implementation with low complexity. The chirp z-transform may be calculated with low complexity through one IFFT and two FFTs by using Bluestein's algorithm

$${Z}_{m}^{( k )}$$

is a vector having M elements and calculated at once for all m.

$${Z}_{m}^{( k )} = {\sum }_{n = 0}^{N - 1} {[ {z}^{( k )} ]}_{n + 1} {( {{e}^{j 2 π {v}_{min} {T}_{c}} ( {e}^{- j 2 π {vT}_{c}} )}^{- m} )}^{- n} , ( m = 0 , 1 , … , M - 1 ) \qquad [ Equation 19 ]$$

Similar to Equation 17, using Equation 19 and Bluestein's algorithm, the Doppler shift estimation value may be acquired as shown in Equation 20. Equation 20 may be calculated with very low complexity through a chirp z-transform. By using the fact that the smallest element of the estimation value candidate set S in Equation 15 is νₘᵢₙ and the largest element is νₘᵢₙ+(M−1)Δν, the Doppler shift estimation value may be acquired by finding the most correlated value among the elements of set S. If the same set S is used, Equation 17 and Equation 20 have the same value.

$$\hat{v} = {v}_{min} + Δ v \cdot {arg max}_{m ∈ \{ 0 , 1 , … , M - 1 \}} \vert {\sum }_{k ∈ {𝒦}_{DMRS}} {e}^{- j 2 π ( {v}_{min} + m Δ v ) {\tilde{N}}^{( k )} {T}_{c}} \cdot {Z}_{m}^{( k )} \vert \qquad [ Equation 20 ]$$

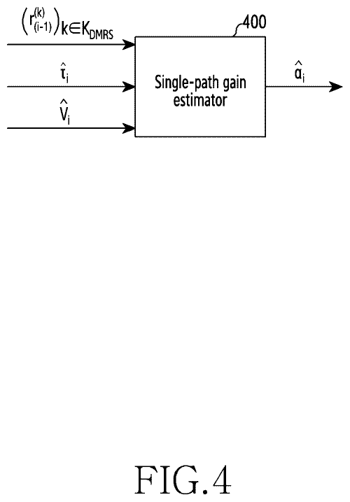

FIG. 4 illustrates a structure of a single-path gain estimator according to an embodiment of the disclosure. The single-path gain estimator 400 may acquire a path gain estimation value \hat{α}ᵢ based on the residual received signal

$${r}_{( i - 1 )}^{( k )} ,$$

k∈ [symbol] _{DMRS} of the pilot symbols, the delay of the corresponding path, and the Doppler shift \hat{ν}ᵢ. In this case, the delay estimation value \hat{τ}ᵢ acquired from the single-path delay estimator 200 may be used as the delay, and the Doppler shift estimation value \hat{ν}ᵢ acquired from the single-path Doppler shift estimator 300 may be used as the Doppler shift. Using the matrix-valued function R^{(k)}(ν) of Equation 16, the circular shift function, and the integer rounding function, and using the least-squares method, the path gain \hat{α} may be estimated as in Equation 21.

$$\hat{α} = \frac{{\sum }_{k ∈ {𝒦}_{DMRS}} {[ {R}^{( k )} ( \hat{v} ) \cdot circshift ( {s}^{( k )} , round ( \frac{\hat{τ}}{{T}_{c}} ) ) ]}^{H} {r}^{( k )}}{{\sum }_{k ∈ {𝒦}_{DMRS}} {‖ {R}^{( k )} ( \hat{v} ) \cdot circshift ( {s}^{( k )} , round ( \frac{\hat{τ}}{{T}_{c}} ) ) ‖}^{2}} \qquad [ Equation 21 ]$$

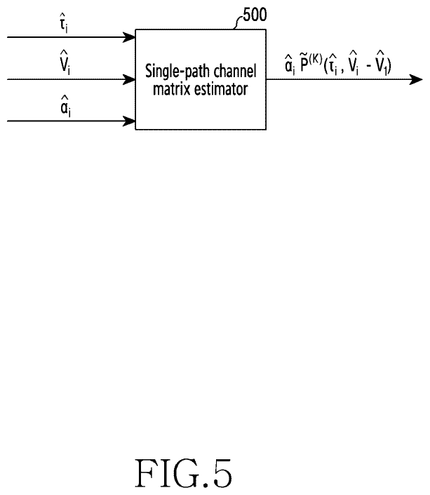

FIG. 5 illustrates a structure of a single-path channel matrix estimator according to an embodiment of the disclosure.

The single-path channel matrix estimator 500 may estimate the path channel matrix

$${\hat{P}}_{i}^{( k )}$$

by using the delay, the estimation value \hat{τ}ᵢ, the Doppler shift estimation value \hat{ν}ᵢ, and the gain estimation value \hat{α}ᵢ for the iₜₕ single path (Equation 22). In this case, a value for which the Doppler shift of the strongest path is corrected is used as the Doppler shift estimation value.

$${\hat{P}}_{i}^{( k )} = {\hat{α}}_{i} {\tilde{P}}^{( k )} ( {\hat{τ}}_{i} , {\hat{v}}_{i} - {\hat{v}}_{1} ) \qquad [ Equation 22 ]$$

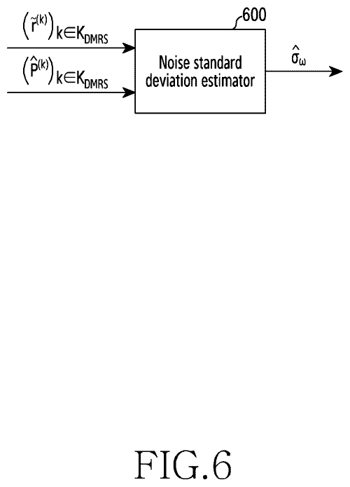

FIG. 6 illustrates a structure of a noise standard deviation estimator according to an embodiment of the disclosure.

Referring to FIG. 6, the noise standard deviation estimator 600 estimates the standard deviation \hat{σ}_{w} of the noise signal based on the estimation channel matrix \hat{P}^{(k)} for which the Doppler shift of the strongest path of the pilot symbols is corrected and the received signal vector \tilde{r}^{(k)} for which the Doppler shift of the strongest path is corrected.

Equation 23 denotes a channel matrix \hat{P}^{(k)} of kₜₕ OFDM symbol estimated up to now from the iₜₕ iteration, and Equation 24 denotes a received signal vector \tilde{r}^{(k)} for which the Doppler shift of the strongest path is corrected.

$${\hat{P}}^{( k )} = {\sum }_{l = 1}^{\hat{L}} {\hat{α}}_{l} {\tilde{P}}^{( k )} ( {\hat{τ}}_{l} , {\hat{v}}_{l} - {\hat{v}}_{1} ) \qquad [ Equation 23 ]$$

$${\tilde{r}}^{( k )} = {[ {R}^{( k )} ( {\hat{v}}_{1} ) ]}^{H} {r}^{( k )} \qquad [ Equation 24 ]$$

The standard deviation \hat{σ}_{w} of the noise may be calculated using the channel matrix estimation value \hat{P}^{(k)} for which the Doppler shift of the strongest path is corrected and the received signal vector estimation value \tilde{r}^{(k)} for which the Doppler shift of the strongest path is corrected (Equation 25).

$${\hat{σ}}_{w} = \sqrt{\frac{{\sum }_{k ∈ {𝒦}_{DMRS}} {( {\tilde{r}}^{( k )} - {\hat{P}}^{( k )} {s}^{( k )} )}^{H} ( {\tilde{r}}^{( k )} - {\hat{P}}^{( k )} {s}^{( k )} )}{\vert {𝒦}_{DMRS} \vert N - 1}} \qquad [ Equation 25 ]$$

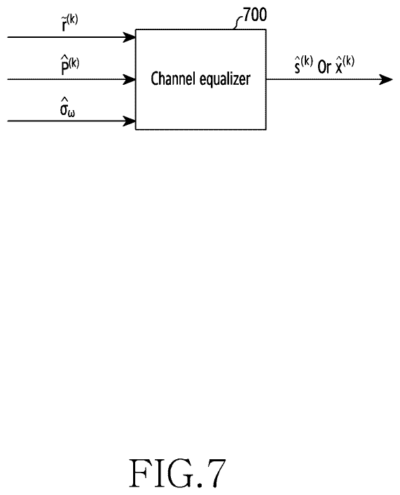

FIG. 7 illustrates a structure of a channel equalizer according to an embodiment of the disclosure.

A channel equalizer according to an embodiment of the disclosure may acquire a time domain transmission signal vector estimation value or a frequency domain transmission signal vector estimation value, based on a time domain channel matrix estimation value for which the Doppler shift of the strongest path is corrected and a time domain received signal vector estimation value for which the Doppler shift of the strongest path is corrected.

Specifically, the channel equalizer may convert the time domain channel matrix estimation value for which the Doppler shift of the strongest path is corrected and the time domain received signal vector estimation value for which the Doppler shift of the strongest path is corrected to a frequency domain. The channel equalizer 700 may acquire a frequency domain transmission signal vector estimation value by using the frequency domain channel matrix estimation value and the frequency domain received signal vector estimation value. In addition, a time domain transmission signal vector estimation value may be acquired based on the frequency domain transmission signal vector estimation value.

Referring to FIG. 7, the channel equalizer 700 may acquire an estimation value ŝ^{(k)} of the time-domain OFDM symbol transmission vector s^{(k)} (or an estimation value \hat{x}^{(k)} of the frequency-domain OFDM symbol transmission vector x^{(k)}), based on the time domain channel matrix estimation value for which the Doppler shift of the strongest path is corrected \hat{P}^{(k)}, the time domain received signal vector estimation value for which the Doppler shift of the strongest path is corrected \tilde{r}^{(k)}, and the noise standard deviation estimation value \hat{σ}_{w}.

For example, the time domain channel matrix estimation value \hat{P}^{(k)} may be converted to the frequency domain channel matrix estimation value Ĥ^{(k)} by using Equation 26, the time domain received signal vector estimation value \tilde{r}^{(k)} may be converted to the frequency domain received signal vector y^{(k)} by using Equation 34, and the frequency domain transmission signal vector estimation value \hat{x}^{(k)} may be converted to the time domain transmission signal vector estimation value ŝ^{(k)} by using Equation 28. In Equation 27 and Equation 28, W denotes a DFT matrix.

$${\hat{H}}^{( k )} = {W}_{N} {\hat{P}}^{( k )} {W}_{N}^{H} \qquad [ Equation 26 ]$$

$${y}^{( k )} = W {\tilde{r}}^{( k )} \qquad [ Equation 27 ]$$

$${\hat{x}}^{( k )} = W {\hat{s}}^{( k )} \qquad [ Equation 28 ]$$

A channel equalizer according to an embodiment of the disclosure may approximate a channel matrix to a band matrix to equalize the channel matrix with low complexity after converting a received signal and a channel matrix to a frequency domain, respectively. In addition, a block diagonal matrix conversion may be used to calculate the inverse matrix quickly. In other words, a channel equalizer may use band matrix approximation and block diagonal matrix conversion in to acquire (equalize) a frequency domain transmission signal estimation value simply and quickly.

For example, the channel equalizer may use the band matrix approximation of Equation 29.

$${B}^{( k )} = band ( {\hat{H}}^{( k )} , 2 q + 1 ) \qquad [ Equation 29 ]$$

Equation 29 defines a matrix B^{(k)} having 2q+1 diagonals by approximating the frequency domain estimation channel matrix Ĥ^{(k)} as a band matrix. For example, when q=0, B^{(k)} is a diagonal matrix where all components except for the diagonal are 0 in Ĥ^{(k)}, when q=1, B^{(k)} is a tridiagonal matrix which may be acquired by setting all components except for three diagonals in Ĥ^{(k)} to 0. From B^{(k)} in Equation 29, a submatrix having a size of (2q+1)×(2q+1) may be acquired using the non-zero elements (Equation 30).

$${\tilde{B}}^{( k )} ( n ) = [ \begin{matrix}{[ {B}^{( k )} ]}_{n - q , n - q} & … & {[ {B}^{( k )} ]}_{n - q , n + q} \\ ⋮ & ⋱ & ⋮ \\ {[ {B}^{( k )} ]}_{n + q , n - q} & … & {[ {B}^{( k )} ]}_{n + q , n + q}\end{matrix} ] , \qquad [ Equation 30 ]$$

$$n ∈ \{ q + 1 , q + 2 , … , N - q \}$$

Using Equation 30, a block diagonal matrix D^{(k)} having a size of (2q+1) (N−2q)×(2q+1) (N−2q) may be acquired (Equation 31).

$${D}^{( k )} = [ \begin{matrix}{\tilde{B}}^{( k )} ( q + 1 ) & & \\ & ⋱ & \\ & & {\tilde{B}}^{( k )} ( N - q )\end{matrix} ] \qquad [ Equation 31 ]$$

In the case of a block diagonal matrix such as in Equation 31, when the inverse matrix of each block matrix is calculated, the inverse matrix of the block diagonal matrix is also calculated, so the complexity of calculating the inverse matrix may be reduced.

In addition, the frequency domain received signal vector y^{(k)} may be mapped to the relationship of B^{(k)} in Equation 29 and \tilde{B}^{(k)}(n) in Equation 30 to acquire the vector b^{(k)}(n) in Equation 32.

$${b}^{( k )} ( n ) = [ \begin{matrix}{[ {y}^{( k )} ]}_{n - q} \\ ⋮ \\ {[ {y}^{( k )} ]}_{n + q}\end{matrix} ] , n ∈ \{ q + 1 , q + 2 , … , N - q \} \qquad [ Equation 32 ]$$

The transmission signal vector estimation value \hat{x}^{(k)} in the frequency domain may be acquired from Equation 26 to Equation 28, and may be represented by Equation 33.

$$[ Equation 33 ]$$

$${[ {\hat{x}}^{( k )} ]}_{n} = \{ \begin{matrix}\begin{matrix}[ [ {\tilde{B}}^{( k )} ( q + 1 ) {( {\tilde{B}}^{( k )} ( q + 1 ) )}^{H} + \\ {{{\hat{σ}}_{w}^{2} I ]}^{- 1} {b}^{( k )} ( q + 1 ) ]}_{n} ,\end{matrix} & for n = 1 , … , q \\ \begin{matrix}[ [ {\tilde{B}}^{( k )} ( n ) {( {\tilde{B}}^{( k )} ( n ) )}^{H} + \\ {{{\hat{σ}}_{w}^{2} I ]}^{- 1} {b}^{( k )} ( n ) ]}_{q + 1} ,\end{matrix} & for n = q + 1 , … , N - q \\ \begin{matrix}[ [ {\tilde{B}}^{( k )} ( N - q ) {( {\tilde{B}}^{( k )} ( N - q ) )}^{H} + \\ {{{\hat{σ}}_{w}^{2} I ]}^{- 1} {b}^{( k )} ( N - q ) ]}_{n - N + 2 q + 1}\end{matrix} & for n = N - q + 1 , … , N\end{matrix}$$

The first q components of \hat{x}^{(k)} may be acquired using \tilde{B}^{(k)}(q+1) and b^{(k)}(q+1), and the last q components of \hat{x}^{(k)} may be acquired using \hat{B}^{(k)}(N−q) and b^{(k)}(N−q). The remaining components of \hat{x}^{(k)} may be acquired by extracting the center component of

$${[ {\tilde{B}}^{( k )} ( n ) {( {\tilde{B}}^{( k )} ( n ) )}^{H} + {\hat{σ}}_{w}^{2} I ]}^{- 1} {b}^{( k )} ( n ) .$$

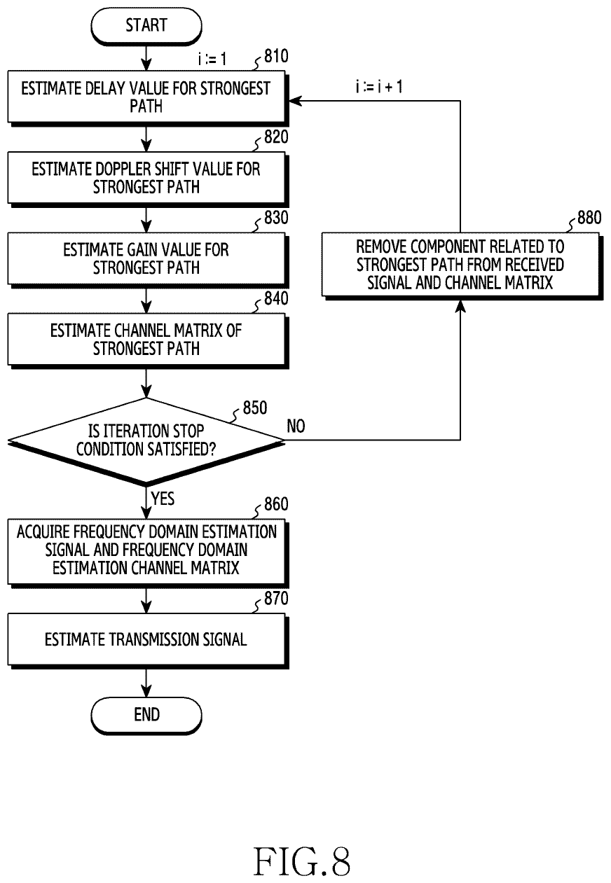

FIG. 8 is a flowchart of the operation of a channel estimator-equalizer according to an embodiment of the disclosure.

Referring to FIG. 8, operations 810 to 850 and operation 880 indicate operations for channel estimation, and operations 860 to 870 indicate operations for channel equalization. In operation 810, a delay value for the strongest path in the iₜₕ path may be estimated.

Operation 810 may be, for example, an operation of acquiring a path delay estimation value by the single-path delay estimator 200 of FIG. 2. Operation 810 may be, for example, to acquire the iₜₕ path delay estimation value by using a coherent combining correlator.

Operation 810 may further include acquiring a delay estimation value, based on a vector value for a received signal and a circular shift value with regard to a vector for a transmitted signal, or based on a fast Fourier transform (FFT) with regard to the vector value for the received signal and the vector value for the transmitted signal and an inverse fast Fourier transform (IFFT) associated with the vector value for the received signal to which the fast Fourier transform is applied and the vector value for the transmitted signal to which the fast Fourier transform is applied.

In operation 820, a Doppler shift value for the strongest path in the iₜₕ path may be estimated. The path delay estimation value of the strongest path acquired in operation 810 is used to estimate a Doppler shift value in operation 820.

Operation 820 may be, for example, an operation of acquiring a path Doppler shift estimation value performed by the single-path Doppler shift estimator 300 of FIG. 3. Operation 820 may be, for example, to acquire an iₜₕ path Doppler offset estimation value by using a coherent combining correlator.

Operation 820 may acquire a Doppler shift estimation value, based on at least one of a circular shift of a transmitted signal and a delay value, a phase rotation in a time domain of a circularly shifted transmitted signal and a delay value, or a chirp Fourier transform for a circularly shifted transmitted signal and a delay value. Operation 820 may be performed with low complexity by using a circular shift, a phase rotation, or a chirp Fourier transform, thereby acquiring a Doppler shift estimation value.

A method for estimating a received signal vector and a channel matrix according to an embodiment uses a value for which a Doppler shift of the strongest path is corrected, in the operations after operation 820. This is to reduce the complexity of the overall method by performing the process of correcting the Doppler shift of the strongest path in advance in subsequent operations by using the corrected value of the Doppler shift of the strongest path.

In operation 830, a gain value for the strongest path in the iₜₕ path may be estimated. The path delay estimation value of the strongest path acquired in operation 810 and the path Doppler shift estimation value of the strongest path acquired in operation 820 may be used in operation 830 to estimate a path gain value.

Operation 830 may be performed based on the least squares approximation. Operation 830 may be, for example, an operation of acquiring a path gain estimation value performed by the path gain estimator 400 of FIG. 4.

In operation 840, a channel matrix of the strongest path in the iₜₕ path may be estimated. The channel matrix of the strongest path may be estimated by using the path delay estimation value of the strongest path acquired in operation 810, the path Doppler shift estimation value of the strongest path acquired in operation 820, and the path gain estimation value of the strongest path acquired in operation 830.

In operation 850, whether an iteration stop condition for stopping the iteration of operation 810 to operation 840 is satisfied may be determined. The iteration stop condition refers to a condition in which a sufficient number of paths may be estimated for the multi-path channel to stop the iteration.

The iteration stop condition may, for example, refer to stopping the iteration when the number of iterations exceeds a specific natural number. The specific natural number may be understood as a maximum number of iterations. The iteration stop condition may, for another example, refer to stopping the iteration when a change in the normalized square error (NSE) of the received signal is less than or equal to a threshold. In addition, the iteration stop condition may refer to stopping the iteration when the number of iterations exceeds a specific natural number Lmax or when a reduction amount of a normalized square error in comparison to a previous iteration is less than or equal to a threshold value.

The NSE in the iₜₕ iteration for determining the iteration stop condition may be represented as in Equation 34.

$${NSE}_{( i )} = \frac{{\sum }_{k ∈ {𝒦}_{DMRS}} {‖ {\tilde{r}}^{( k )} - {\hat{P}}^{( k )} {s}^{( k )} ‖}^{2}}{{\sum }_{k ∈ {𝒦}_{DMRS}} ‖ {\tilde{r}}^{( k )} {‖}^{2}} \qquad [ Equation 34 ]$$

In addition, an iteration stop condition, in which iteration is stopped when the number of iterations exceeds a specific natural number Lmax or a reduction amount of a normalized square error in comparison to a previous iteration is less than or equal to a threshold value ε (ε>0), may be expressed as in Equation 35. In Equation 35, Lmax and threshold value & may be configured differently depending on the channel environment.

$$i > {L}_{m ax} or {NSE}_{( i - 1 )} - {NSE}_{( i )} \leq ε \qquad [ Equation 35 ]$$

The iteration stop conditions of Equations 34 and 35 are only examples and is not limiting the iteration stop conditions of the disclosure.

In operation 850, if it is determined that the iteration stop condition is satisfied, in operation 860, a frequency domain estimation signal and a frequency domain estimation channel matrix for the strongest path in the iₜₕ path may be acquired.

In operation 870, the transmitted signal may be estimated.

In operation 850, if it is determined that the iteration stop condition is not satisfied, in operation 880, a component related to the strongest path may be removed from the received signal and the channel matrix, and operation 810 may be iterated for the (i+1)^{th} path. In other words, after performing channel estimation of the strongest path in operation 840, it may be determined that the iteration stop condition is not satisfied in operation 850, and the influence due to the estimated path may be removed from the received signal and the process of operations 810 to 840 may be iterated again, thereby performing channel estimation of the next strongest path.

The estimation process of the (i+1)ₜₕ path is similar to the estimation process of the iₜₕ path, but in operation 820 of the Doppler shift estimation, since the Doppler shift of the (i+1)ₜₕ path is estimated using the received signal corrected by the amount of the Doppler shift of the iₜₕ strongest path, the estimation value of the Doppler shift of the (i+1)ₜₕ path is acquired as a value corrected by the amount of the Doppler shift of the iₜₕ strongest path.

A channel estimator according to an embodiment of the disclosure may perform multi-path channel estimation by iteratively using a single-path channel estimator.

A channel matrix estimation value for a multi-path channel according to an embodiment of the disclosure may be expressed as a sum of channel matrix estimation values for acquired every single path.

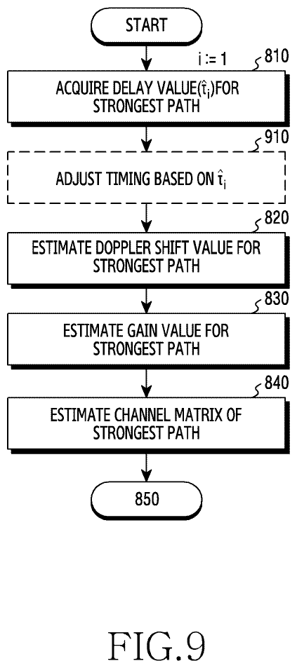

FIG. 9 illustrates an operation method of an embodiment in which a channel estimator-equalizer performs timing adjustment according to an embodiment of the disclosure. Description overlapping with FIG. 8 in operations 810 to 840 of FIG. 9 will be omitted. Operation 910 may be optionally and arbitrarily performed to increase the energy of the received signal and improve the accuracy of the reception performance.

Referring to FIG. 9, the channel estimator-equalizer of the disclosure may adjust the sampling timing of the received signal in operation 910, based on the path delay estimation value acquired in operation 810. Specifically, the sampling timing adjustment may be performed by the matched filter of the channel estimator-equalizer (e.g., the matched filter 110 of FIG. 1).

Specifically, in operation 910, the timing of the received signal vector may be adjusted based on the delay estimation value of the strongest path of the received signal. When a signal having a sampling interval of Tc of the received signal is to be used, in operation 910, the sampling timing of the received signal may be determined by adding \hat{τ}₁ acquired in operation 810 and an integer multiple of Tc.

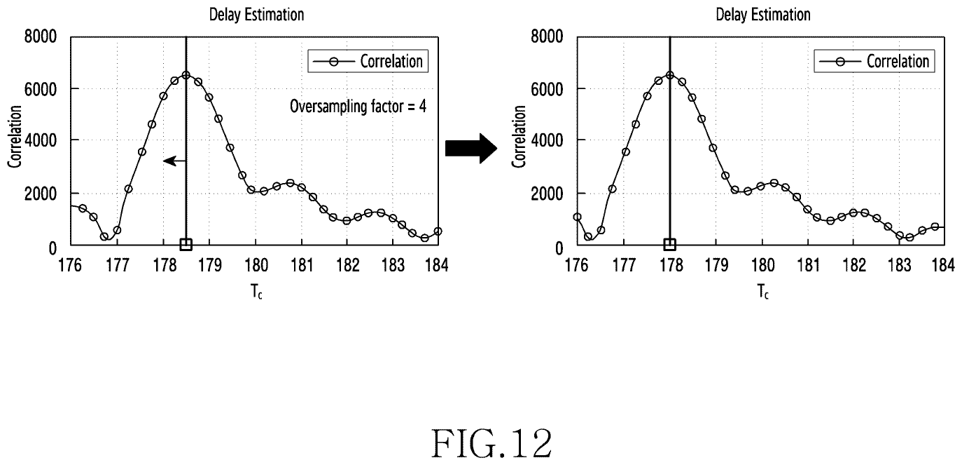

FIG. 12 illustrates an embodiment in which a channel estimator-equalizer adjusts timing by using a delay peak of the strongest path according to an embodiment of the disclosure.

Referring to FIG. 12, before timing adjustment (left graph), the path delay peak of the strongest path is aligned to the middle value of 178-179 of Tc. After timing adjustment (right graph), the path delay peak of the strongest path is aligned to 178, which is an integer multiple of Tc.

Before timing adjustment, the strongest path delay estimation value may be acquired by using an oversampled received signal corresponding to an oversampling factor of 4 (i.e., the sampling rate is 4Tc). After acquiring the strongest path delay estimation value, the sampling rate of the received signal may be reduced to Tc for use.

Alternatively, specifically, operation 910 may adjust the timing of the received signal vector based on the delay estimation value of the first arriving path for the received signal. In order to acquire the delay estimation value of the first arriving path, the performance of the estimator and the equalizer may be improved by including the sample before the correlation peak in the received signal vector.

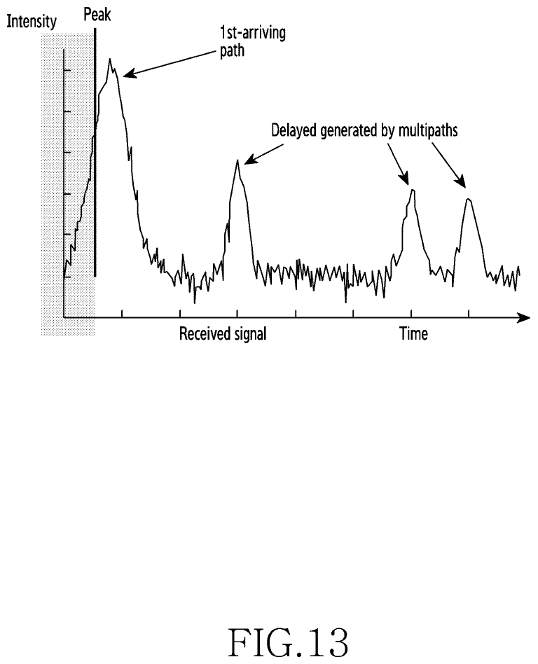

FIG. 13 illustrates an embodiment in which a channel estimator-equalizer integrates the energy of the first arriving path according to an embodiment of the disclosure.

According to an embodiment of the disclosure, the path estimation-channel may adjust the sampling timing of the received signal vector, based on the path delay of the first arriving path, thereby preventing a loss of reception energy. Referring to FIG. 13, the intensity of a received signal varies over time, and a correlation peak of the received signal exists at a specific time. The path channel-estimator may adjust the sampling timing of the received signal vector in order to sample the sample before the correlation peak of the received signal when estimating the path delay. The sampling timing of the received signal vector may be adjusted to match the delay of the first arriving path by using Equation 14.

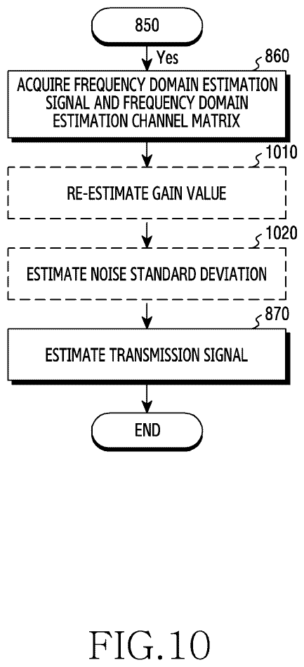

FIG. 10 illustrates an operation method of performing re-estimation of a gain value and estimation of a noise standard deviation by a channel estimator-equalizer according to an embodiment of the disclosure. Description overlapping with FIG. 8 in operations 850 to 870 of FIG. 10 will be omitted. Operation 1010 or operation 1020 may be optionally and arbitrarily performed to improve the accuracy of the reception performance.

In operation 860, when a frequency domain estimation channel matrix is acquired, a gain value for each OFDM symbol may be re-estimated and corrected in operation 1010. Through the gain value re-estimation in operation 1010, an estimation value in which time variation is reflected more accurately may be acquired.

In addition, when the frequency domain estimation channel matrix is acquired in operation 860 or the gain value for each OFDM symbol is re-estimated in operation 1010, the standard deviation or variance of the noise signal may be calculated by using the estimated or re-estimated channel matrix in operation 1020.

To re-estimate the gain value, a matrix A^{(k)} having a size of N× \hat{L} may be defined as in Equation 36, where \hat{L} is the number of estimated paths in Equation 36.

$${A}^{( k )} = [ {\hat{P}}_{1}^{( k )} {s}^{( k )} … {\hat{P}}_{\hat{L}}^{( k )} {s}^{( k )} ] \qquad [ Equation 36 ]$$

In the case of a pilot symbol, Equation 37 may be used to re-estimate the gain value for each pilot symbol.

$${\hat{α}}^{( k )} = [ \begin{matrix}{\hat{α}}_{1}^{( k )} \\ ⋮ \\ {\hat{α}}_{\hat{L}}^{( k )}\end{matrix} ] = {( {( {A}^{( k )} )}^{H} {A}^{( k )} )}^{- 1} {A}^{{( k )}^{H}} {\tilde{r}}^{( k )} \qquad [ Equation 37 ]$$

In the case of an OFDM symbol that is not a pilot symbol, a gain value re-estimated for the pilot symbol may be used by applying linear interpolation or extra interpolation through above Equation 37.

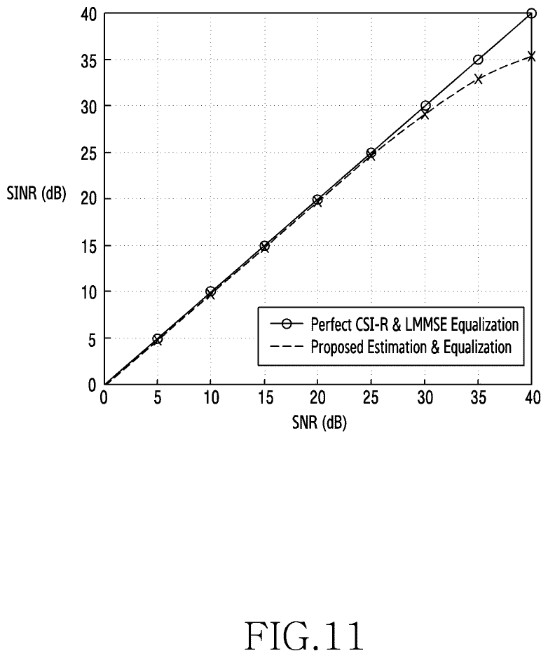

FIG. 11 is a graph illustrating a SINR performance when channel estimation and channel equalization are performed by using a channel estimator-equalizer according to an embodiment of the disclosure. The SINR performance refers to the average signal-to-interference-plus-noise ratio (SINR) performance according to a signal-to-noise ratio (SNR). In the simulation, N=1024, N_{CP}=72, the total number of paths of the channel is 5, the center frequency is 4 GHz, and the UE movement speed is 500 km/h, which are parameters configured to be similar to the standard high-speed train scenario. In addition, it is assumed that there are three DMRS symbols per slot, each corresponding to a pilot symbol. In this case, the average SINR performance at all OFDM symbols within a single slot is shown. When using the channel estimator-equalizer of the disclosure, it may be identified that reception performance comparable to that of using an LMMSE equalizer in a perfect CSI-R is achieved.

A method performed by a reception device in a wireless communication system may include a first operation of estimating a delay value for a strongest path for a received signal; a second operation of estimating a Doppler shift value for the strongest path based on the received signal and the delay value; a third operation of estimating a gain value for the strongest path based on the received signal, the delay value, and the Doppler shift value; a fourth operation of estimating a channel matrix of the strongest path based on the delay value, the Doppler shift value, and the gain value; a fifth operation of acquiring a frequency domain estimation signal and a frequency domain estimation channel matrix by converting the received signal and the channel matrix into a frequency domain when an iteration stop condition for stopping the iteration of the first operation to the fourth operation is satisfied; and a sixth operation of estimating a transmission signal corresponding to the received signal based on the frequency domain estimation signal and the frequency domain estimation channel matrix.

The method performed by the reception device may further include a seventh operation of acquiring a corrected received signal and a corrected channel matrix by removing a component related to the strongest path from the received signal and the channel matrix when the iteration stop condition is not satisfied, and iteratively performing the first operation to the fourth operation on the corrected received signal and the corrected channel matrix.

According to this embodiment, since path parameters (e.g., delay, Doppler shift, gain, etc.) for the strongest first path are estimated and, after removing the influence related to the parameters of the estimated first path, path parameters are estimated again for the next strongest second path and the estimation of this single-path channel is iterated until an iteration stopping condition is satisfied, the next strongest paths are sequentially estimated from the strongest path and a multi-path channel in which a path with a high Doppler shift exists may be effectively estimated with low complexity and high accuracy. In addition, since these estimation results are used for equalization, equalization may be performed with low complexity and high accuracy. Therefore, the reception device of the disclosure may achieve high reception performance with low complexity and high accuracy.

The sampling timing of the received signal in the second operation may be changed based on a sum of the delay value estimated in the first operation and an integer multiple of the sampling timing of the received signal.

According to this embodiment, the sampling timing of the received signal may be aligned with the reception timing of the strongest path based on the estimated delay value. Alternatively, when estimating the delay of the strongest path, the sampling timing of the received signal may be aligned with the correlation peak. By aligning the sampling timing of the received signal with the reception timing of the strongest path, the sampling rate of the received signal may be reduced (decimated). This reduction in sampling rate allows for estimation with lower complexity. Therefore, according to this embodiment, even when using oversampled or upsampled received signals to improve estimation resolution, the complexity of the estimation may be lowered by reducing the sampling rate by changing the timing of the received signal based on the estimated delay value for the strongest path, thereby achieving both low complexity and high accuracy.

The component to be removed may be a component corresponding to the Doppler shift value.

According to this embodiment, by removing the Doppler shift value of the first path, the Doppler shift value of the received signal and channel matrix may be corrected, thereby reducing the complexity of the overall operation. In addition, pre-equalization preprocessing, such as phase de-rotation of the received signal by the Doppler shift of the strongest path before equalization, may reduce leakage when estimating the FD channel matrix (improving equalization performance such as lower complexity, etc.). This embodiment allows for the joint implementation of the channel estimator and channel equalizer, thereby reducing the operational complexity of the reception device.

In the method performed by the reception device, the iteration stop condition may be that a change in the normalized square error (NSE) of the received signal is equal to or less than a threshold value.

The sixth operation may further include approximating the frequency-domain estimation channel matrix into a band matrix; and converting the approximated band matrix into a block diagonal matrix.

By utilizing such band matrix approximation, the complexity of the equalization operation may be reduced.

In the method performed by the reception device, the first operation may further include adjusting a timing of a received signal vector based on a delay value of the first arriving path for the received signal.

By changing the timing of the received signal vector based on the delay value of the first arriving path, samples prior to the correlation peak may be included in the received vector when estimating the delay of the first path, thereby increasing the received energy and improving the performance of the channel estimator-equalizer.

The fifth operation may further include, when the iteration stop condition is satisfied, re-estimating a gain value for each symbol based on the received signal and the channel matrix prior to performing the sixth operation.

For DMRS symbols, channel estimation accuracy for symbols far from the slot center may be improved by re-estimating the path gain at each OFDM symbol.

The fifth operation may further include, when the iteration stop condition is satisfied, acquire a standard deviation estimation value of a noise signal by using the received signal and the channel matrix, and the standard deviation estimation value of the noise signal may be converted to the frequency domain in the sixth operation and may be used to estimate the transmission signal in the seventh operation.

By acquiring a standard deviation estimation value of the noise signal, the symbol-level channel estimation accuracy may be improved.

The delay value may be estimated based on a vector value for the received signal and a circular shift value with regard to a vector for the transmitted signal, or based on a fast Fourier transform (FFT) with regard to the vector value for the received signal and the vector value for the transmitted signal and an inverse fast Fourier transform (IFFT) associated with the vector value for the received signal to which the fast Fourier transform is applied and the vector value for the transmitted signal to which the fast Fourier transform is applied.

When estimating the delay value, by using FFT, IFFT, or chirp Fourier transform, only one vector may be calculated for arg max function calculation, thereby reducing the complexity of estimation.

A reception device according to an embodiment of the disclosure may include a matched filter configured to perform sampling of a received signal to generate a received signal vector; a channel estimator; and a channel equalizer, wherein the channel estimator may be configured to estimate a delay value for a strongest path for the received signal, estimate a Doppler shift value for the strongest path based on the received signal and the delay value, estimate a gain value for the strongest path based on the received signal, the delay value, and the Doppler shift value, and estimate a channel matrix of the strongest path based on the delay value, the Doppler shift value, and the gain value, and wherein the channel equalizer may be configured to acquire a frequency domain estimation signal and a frequency domain estimation channel matrix by converting the received signal and the channel matrix into a frequency domain when an iteration stop condition for stopping the iteration of the first operation to the fourth operation is satisfied, and estimate a transmission signal corresponding to the received signal based on the frequency domain estimation signal and the frequency domain estimation channel matrix.

The channel estimator may be further configured to perform a seventh operation of acquiring a corrected received signal and a corrected channel matrix by removing a component related to the strongest path from the received signal and the channel matrix when the iteration stop condition is not satisfied, and iteratively performing the first operation to the fourth operation on the corrected received signal and the corrected channel matrix.

The matched filter may be further configured to change the sampling timing of the received signal in the second operation based on a sum of the delay value estimated in the first operation and an integer multiple of the sampling timing of the received signal.

The component to be removed may be a component corresponding to the Doppler shift value.

The iteration stop condition may be that a change in the normalized square error (NSE) of the received signal is equal to or less than a threshold value.

The channel equalizer may be further configured to approximate the frequency-domain estimation channel matrix into a band matrix; and convert the approximated band matrix into a block diagonal matrix.

The matched filter may be further configured to adjust a timing of a received signal vector based on a delay value of the first arriving path for the received signal.

The channel estimator may be further configured to, when the iteration stop condition is satisfied, re-estimate a gain value for each symbol based on the received signal and the channel matrix.

The channel estimator may be further configured to, when the iteration stop condition is satisfied, acquire a standard deviation estimation value of a noise signal by using the received signal and the channel matrix, and the standard deviation estimation value of the noise signal may be converted to the frequency domain in the sixth operation and may be used to estimate the transmission signal in the seventh operation.

The channel estimator may be further configured to estimate the delay value based on a vector value for the received signal and a circular shift value with regard to a vector for the transmitted signal, or based on a fast Fourier transform (FFT) with regard to the vector value for the received signal and the vector value for the transmitted signal and an inverse fast Fourier transform (IFFT) associated with the vector value for the received signal to which the fast Fourier transform is applied and the vector value for the transmitted signal to which the fast Fourier transform is applied.

The electronic device according to various embodiments set forth herein may be one of various types of electronic devices. The electronic device may include, for example, a portable communication device (e.g., a smart phone), a computer device, a portable multimedia device, a portable medical device, a camera, a wearable device, or a home appliance. The electronic device according to embodiments of the disclosure is not limited to those described above.

The embodiments and the terms used therein are not intended to limit the technological features set forth herein to particular embodiments and the disclosure includes various changes, equivalents, or alternatives for a corresponding embodiment. With regard to the description of the drawings, similar reference numerals may be used to designate similar or relevant elements. A singular form of a noun corresponding to an item may include one or more of the items, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. Such terms as “a first”, “a second”, “the first”, and “the second” may be used to simply distinguish a corresponding element from another, and does not limit the elements in other aspect (e.g., importance or order). If an element (e.g., a first element) is referred to, with or without the term “operatively” or “communicatively”, as “coupled with/to” or “connected with/to” another element (e.g., a second element), it means that the element may be coupled/connected with/to the other element directly (e.g., through at least one wire), wirelessly, or via a third element.

As used herein, the term “module” may include a unit implemented in hardware, software, or firmware, and may interchangeably be used with other terms, for example, “logic”, “logic block”, “part”, or “circuitry”. The “module” may be a single integrated component, or a minimum unit or part thereof, adapted to perform one or more functions. For example, according to an embodiment, the “module” may be implemented in the form of an application-specific integrated circuit (ASIC).

Various embodiments as set forth herein may be implemented as software (e.g., a program) including one or more instructions that are stored in a storage medium (e.g., an internal memory or external memory) that is readable by a machine (e.g., an electronic device). For example, a processor of the machine (e.g., an electronic device) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Herein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, methods according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each element (e.g., a module or a program) of the above-described elements may include a single entity or multiple entities, and some of the multiple entities may be separately disposed in any other element. According to various embodiments, one or more of the above-described elements or operations may be omitted, or one or more other elements or operations may be added. Alternatively or additionally, a plurality of elements (e.g., modules or programs) may be integrated into a single element. In such a case, according to various embodiments, the integrated element may still perform one or more functions of each of the plurality of elements in the same or similar manner as they are performed by a corresponding one of the plurality of elements before the integration.

According to various embodiments, operations performed by the module, the program, or another element may be carried out sequentially, in parallel, repeatedly, or heuristically, or one or more of the operations may be executed in a different order or omitted, or one or more other operations may be added.

Symbols of the present disclosure are summarized herein:
N: IFFT size
NCP: Length of cyclic prefix
L: Number of paths
Tc: sample period
IN: N×N identity matrix
OM×N: M×N all-zero matrix
1M×N: M×N all-one matrix
W: DFT matrix
[symbol] _{DMRS}: A set of indices of OFDM symbols corresponding to pilot symbols in one slot (when there are 14 OFDM symbols in one slot, {1, 2, . . . , 14})
⊙: Hadamard product operator of two matrices or vectors
FFT(·): Fast Fourier transform function
IFFT(·): Inverse fast Fourier transform function
circshift(ν, k): Function of circularly shifting row vector ν by k downward
round(·): Function for rounding to integer
band (A, 2k+1): Function of changing all components other than central 2k+1 diagonals of matrix A to 0
[v]k: kth component of vector v k≥1

What is claimed is:

1. A method performed by a reception device in a wireless communication system, the method comprising:
a first operation of estimating a delay value for a strongest path for a received signal;
a second operation of estimating a Doppler shift value for the strongest path based on the received signal and the delay value;
a third operation of estimating a gain value for the strongest path based on the received signal, the delay value, and the Doppler shift value;
a fourth operation of estimating a channel matrix of the strongest path based on the delay value, the Doppler shift value, and the gain value;
in a case that an iteration stop condition for stopping an iteration of the first operation to the fourth operation is satisfied, a fifth operation of acquiring a frequency domain estimation signal and a frequency domain estimation channel matrix by converting the received signal and the channel matrix into a frequency domain; and
a sixth operation of estimating a transmission signal corresponding to the received signal based on the frequency domain estimation signal and the frequency domain estimation channel matrix.

2. The method of claim 1, further comprising:
in a case that the iteration stop condition is not satisfied, a seventh operation of acquiring a corrected received signal and a corrected channel matrix by removing a component related to the strongest path from the received signal and the channel matrix, and
iteratively performing the first operation to the fourth operation on the corrected received signal and the corrected channel matrix.

3. The method of claim 1, wherein a sampling timing of the received signal in the second operation is changed based on a sum of the delay value estimated in the first operation and an integer multiple of the sampling timing of the received signal.

4. The method of claim 2, wherein the component to be removed corresponds to the Doppler shift value.

5. The method of claim 1, wherein, in the iteration stop condition, a change in the normalized square error (NSE) of the received signal is equal to or less than a threshold value.

6. The method of claim 1, wherein the first operation further comprises adjusting a timing of a received signal vector based on a delay value of a first arriving path for the received signal.

7. The method of claim 1, wherein the fifth operation further comprises, in the case that the iteration stop condition is satisfied, re-estimating a gain value for each symbol based on the received signal and the channel matrix prior to performing the sixth operation.

8. A reception device comprising:
a matched filter configured to perform sampling of a received signal to generate a received signal vector;
a channel estimator; and
a channel equalizer,
wherein the channel estimator is configured to perform:
a first operation of estimating a delay value for a strongest path for the received signal;
a second operation of estimating a Doppler shift value for the strongest path based on the received signal and the delay value;
a third operation of estimating a gain value for the strongest path based on the received signal, the delay value, and the Doppler shift value; and
a fourth operation of estimating a channel matrix of the strongest path based on the delay value, the Doppler shift value, and the gain value, and
wherein the channel equalizer is configured to perform:
in a case that an iteration stop condition for stopping an iteration of the first operation to the fourth operation is satisfied, a fifth operation of acquiring a frequency domain estimation signal and a frequency domain estimation channel matrix by converting the received signal and the channel matrix into a frequency domain; and
a sixth operation of estimating a transmission signal corresponding to the received signal based on the frequency domain estimation signal and the frequency domain estimation channel matrix.

9. The reception device of claim 8, wherein the channel estimator is further configured to perform:
in a case that the iteration stop condition is not satisfied, a seventh operation of acquiring a corrected received signal and a corrected channel matrix by removing a component related to the strongest path from the received signal and the channel matrix, and
iteratively performing the first operation to the fourth operation on the corrected received signal and the corrected channel matrix.

10. The reception device of claim 8, wherein the matched filter is further configured to change a sampling timing of the received signal in the second operation based on a sum of the delay value estimated in the first operation and an integer multiple of the sampling timing of the received signal.

11. The reception device of claim 9, wherein the component to be removed corresponds to the Doppler shift value.

12. The reception device of claim 8, wherein, in the iteration stop condition, a change in the normalized square error (NSE) of the received signal is equal to or less than a threshold value.

13. The reception device of claim 8, wherein the matched filter is further configured to adjust a timing of a received signal vector based on a delay value of a first arriving path for the received signal.

14. The reception device of claim 8, wherein the channel estimator is further configured to, in the case that the iteration stop condition is satisfied, re-estimate a gain value for each symbol based on the received signal and the channel matrix.

15. The reception device of claim 9, wherein the channel estimator is further configured to, in the case that the iteration stop condition is satisfied, acquire a standard deviation estimation value of a noise signal by using the received signal and the channel matrix, and
wherein the standard deviation estimation value of the noise signal is converted to the frequency domain in the sixth operation and is used to estimate the transmission signal in the seventh operation.
